(19) United States
(12) Patent Application Publication
(10) Pub. No.: US 2026/0247517 A1
(43) Pub. Date: Aug. 20, 2026

(54) Apparatus for Controlling a Composition of a Plasma

(71) Applicant: The University of Liverpool, Liverpool (GB)

(72) Inventors: James Walsh, Liverpool (GB); Aaron Dickenson, Liverpool (GB)

(21) Appl. No.: 19/160,958

(22) PCT Filed: Mar. 1, 2024
(86) PCT No.: PCT/GB2024/050565

§ 371 Date: Aug. 29, 2025

(30) Foreign Application Priority Data
Mar. 2, 2023 (GB) 2303104.0

(51) Int. Cl. H05H 1/00; H05H 1/24

(52) U.S. Cl. CPC H05H 1/01; H05H 1/0037; H05H 1/2441; H05H 2242/10; H05H 2245/15

(57) ABSTRACT

Disclosed is an apparatus for controlling a composition of a plasma, comprising a pair of electrodes having a dielectric barrier therebetween, the apparatus further comprising: a temperature control unit in thermal contact with one of the electrodes or the dielectric barrier; a sensor configured to measure a temperature of one of electrodes or the dielectric barrier; a detector configured to determine a concentration of a primary chemical species of the plasma; and a processor configured to control the temperature control unit based on the measured temperature and the determined concentration.

### FIELD

The invention relates to an apparatus for controlling a composition of a plasma and a method of controlling a composition of a plasma.

### BACKGROUND TO THE INVENTION

Plasma technology is used across a plethora of industries. For example, plasma technologies have found applications ranging from the manufacture of automotives to medicine. Several variables determine the suitability of a plasma for a particular application. Composition, electron and ion temperatures and electron and ion densities, for example, each impact on the usefulness of a plasma for a particular application. However, it is currently not well understood how to control a plasma's composition.

Hence, there is a need for an apparatus for controlling a composition of a plasma. Similarly, there is a need for an apparatus that facilitates different chemical regimes of plasma generation. Overall, there is a desire to provide an apparatus and method for plasma species generation control.

### SUMMARY OF THE INVENTION

It is one aim of the invention, amongst others, to provide an apparatus for controlling a composition of a plasma which at least partially obviates or mitigates at least some of the disadvantages of the prior art, whether identified herein or elsewhere or to provide an alternative approach. According to the invention, there is provided an apparatus for controlling a composition of a plasma and a method of controlling a composition of a plasma, as set forth in the independent claims. Other aspects of the invention are set forth in the dependent claims and the description.

According to a first aspect of the present invention, there is provided an apparatus for controlling a composition of a plasma, comprising a pair of electrodes having a dielectric barrier therebetween, the apparatus further comprising: a temperature control unit in thermal contact with one of the electrodes or the dielectric barrier; a sensor configured to measure a temperature of one of electrodes or the dielectric barrier; a detector configured to determine a concentration of a primary chemical species of the plasma; and a processor configured to control the temperature control unit based on the measured temperature and the determined concentration.

In an embodiment, a power source for attachment to the pair of electrodes is electrically insulated from the temperature control unit.

In an embodiment, in a first mode: the processor is configured to determine whether the concentration is above a first predetermined threshold, the first predetermined threshold being zero, and the processor is configured to control the temperature control unit only if the concentration is above the first predetermined threshold.

In an embodiment, in a second mode: the processor is configured to determine whether the concentration is above a second predetermined threshold, the second predetermined threshold being non-zero, and the processor is configured to control the temperature control unit only if the concentration is above the second predetermined threshold.

In an embodiment, the apparatus is switchable between the first mode and the second mode.

In an embodiment, the primary chemical species is a reactive nitrogen species.

In an embodiment, the detector is configured to detect nitrogen dioxide.

In an embodiment, the primary chemical species is a reactive oxygen species.

In an embodiment, the detector is configured to detect ozone.

In an embodiment, the detector comprises at least one of a UV spectrometer and an IR spectrometer.

In an embodiment, the sensor comprises a thermocouple.

In an embodiment, the temperature control unit is attachable to the one electrode or the dielectric barrier via a thermal interface material.

In an embodiment, the temperature control unit is one of a thermoelectric module or a temperature-controlled fluid system.

In an embodiment, the dielectric material comprises at least one of alumina and quartz.

In an embodiment, the apparatus is arranged in either a surface barrier discharge, SBD, configuration or a dielectric barrier discharge, DBD, configuration.

According to a second aspect of the present invention, there is provided a method of controlling a composition of a plasma generated by a pair of electrodes having a dielectric barrier therebetween, the method comprising: providing a temperature control unit in thermal contact with one of the electrodes or the dielectric barrier; measuring a temperature of one of the electrodes or the dielectric barrier using a sensor; determining a concentration of a primary chemical species of the plasma using a detector; and controlling the temperature control unit based on the measured temperature and the determined concentration.

According to a third aspect, there is provided a transitory or non-transitory computer-readable medium comprising instructions which, when executed by a computer, cause the computer to carry out the steps of the method of the second aspect.

### BRIEF DESCRIPTION OF THE DRAWINGS

For a better understanding of the invention, and to show how exemplary embodiments of the same may be brought into effect, reference will be made, by way of example only, to the accompanying drawings, in which:

FIGS. 1A and 1B each show an apparatus for controlling a composition of a plasma according to an embodiment; and

FIGS. 2A and 2B show the relationship between temperature and plasma composition.

FIG. 3 shows a method of controlling a composition of a plasma according to an embodiment.

### DETAILED DESCRIPTION

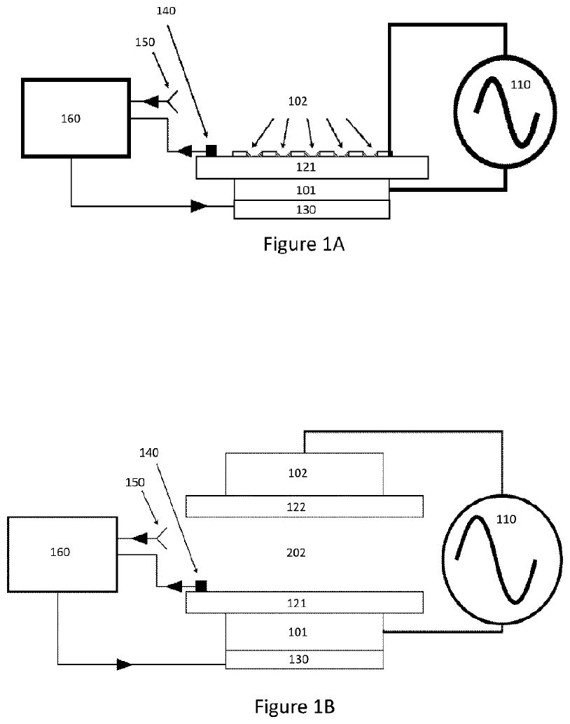

FIGS. 1A and 1B each show an apparatus for controlling a composition of a plasma at atmospheric pressure according to an embodiment. In both FIGS. 1A and 1B the apparatus is shown in use with a first electrode 101 and a second electrode 102, the electrodes 101, 102 being coupled to a power source 110. FIG. 1A shows the apparatus as part of a surface barrier discharge (SBD) configuration and FIG. 1B shows the apparatus as part of a dielectric barrier discharge (DBD) configuration.

An SBD configuration, as shown in FIG. 1A, typically comprises a plate-like first electrode 101 and a second electrode 102, the second electrode comprising gaps (e.g., indentations or grooves) at intervals. A first dielectric barrier 121 is between the first electrode 101 and the second electrode 102. By applying a time-varying electric field across the electrodes 101, 102, plasma is generated from gas present between the gaps spaced along the second electrode 102.

A DBD configuration, as shown in FIG. 1B, typically comprises two plate-like electrodes 101, 102. A first dielectric barrier 121 is connected (e.g., attached) to the first electrode 101. A second dielectric barrier 122 is optionally connected (e.g., attached) to the second electrode 102. The power source 110 is coupled to the first electrode 101 and the second electrode 102. A gap 202 is present between the first dielectric barrier 121 and the second electrode 102 or, in the case of a second dielectric barrier 122 being connected to the second electrode 102, between the first dielectric barrier 121 and the second dielectric barrier 122. A plasma forms in the gap 202 when a time-varying electric field is applied across the electrodes 101, 102.

The first dielectric barrier 121, and, in the case of the DBD configuration, the second dielectric barrier 122, may comprise at least one of alumina and quartz. Advantageously, alumina/quartz have a relatively high thermal conductivity and low dielectric loss tangent, allowing for effective heating/cooling of plasma contact/generating surfaces.

As shown in FIGS. 1A and 1B, the apparatus comprises a temperature control unit 130 attachable to the first electrode 101. The temperature control unit 130 enables temperature control of the first electrode 101. Conventionally, in generation of plasma the only temperature control of electrodes performed relates to cooling of the electrodes, as it is assumed that any changes to the composition of plasma generated is a consequence of heating of electrodes. However, it has been found that there is no direct relationship between increasing temperature and breakdown of certain molecules of plasma (e.g., ozone) at atmospheric pressure. In other words, it is not simply cooling of electrodes which is important for controlling plasma composition but heating and cooling of electrodes. Further, it has been found that dynamically heating and cooling of electrodes gives rise to well-controlled species generation.

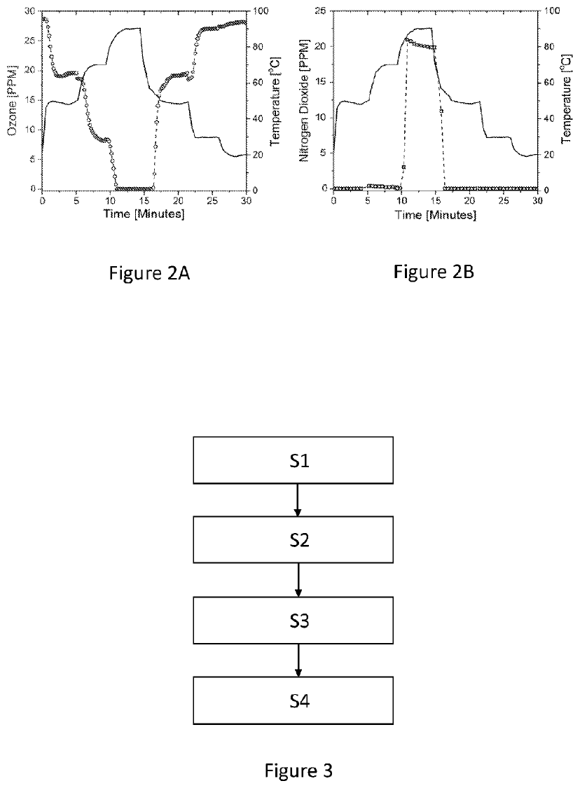

FIGS. 2A and 2B show the relationship between temperature and a composition of a plasma generated at atmospheric pressure. FIG. 2A shows the relationship between temperature (unbroken line) and the parts per million in a plasma of ozone (broken line) over time, and FIG. 2B shows the relationship between temperature (unbroken line) and the parts per million in a plasma of nitrogen dioxide (broken line) over time. As can be understood from FIGS. 2A and 2B, the relationship between temperature and plasma composition is not a straightforward linear relationship, and precise temperature control (heating and cooling) of electrodes is important for controlling plasma composition.

Advantageously, the temperature control unit 130 allows cooling and heating of the first electrode 101 or dielectric 121, 122 to be performed. It is found that by controlling the temperature of at least one of the electrodes and dielectrics, then better control of the entire system can be achieved. In reality, given the close proximity of e.g. electrode 101 and dielectric 121, as shown in FIGS. 1A and 1B, then temperature control of one of the elements, changes the temperature of the other as well. Preferably, the temperature control unit is a thermoelectric module (Peltier module). Advantageously, use of a thermoelectric module enables rapid switching between cooling and heating, which is vital to maintain generation of a plasma with a particular desired composition. Moreover, compared with, for example water cooling/heating, use of the thermoelectric module facilitates dynamic cooling and heating of the first electrode 101 on a short time scale, although with a suitable fluid-based system, this can be a feasible alternative. Another advantage of thermoelectric modules is that they are easily combinable, meaning that a plurality of thermoelectric modules may be used to scale up/down the area over which plasma is generated. Consequently, plasma may be generated over a larger surface area treatment or at higher density depending on how the plurality of thermoelectric modules is arranged.

The temperature control unit 130 may be attachable to the first electrode 101 via a thermal interface material such as a pad or a paste (e.g., glue, resin, adhesive, cement). Advantageously, the thermal interface material allows efficient thermal transfer from the temperature control unit 130 to the first electrode 101. The temperature control unit 130 is typically attached at a grounded side of the apparatus.

Another form of temperature control which may be utilised involves the use of a heated or cooled fluid. A suitable fluid is water, but other fluids may be utilised as required. In certain implementations, a mineral oil may be used as it has suitable thermal properties and is an electrical insulator, which can be important in a system such as this which utilises high voltages. In such a system, the temperature-controlled fluid is piped in thermal contact with the first electrode 101 in much the same manner as the Peltier device referred to above i.e., the pipe carrying the fluid is attached to the first electrode via a thermal interface material to ensure good thermal contact between the pipe and the first electrode.

In another embodiment, the temperature-controlled fluid is run through the body of an electrode or dielectric in embedded pipes or pathways. This arrangement allows for excellent thermal transfer between the electrode/dialectic and the fluid, enabling better and faster temperature control to be exercised. In larger scale systems, such an arrangement is likely to be more energy efficient and cost-effective than a Peltier-based system, although both have merits and can be used.

A fluid-based temperature control system is still able to offer rapid temperature control and is able to be installed and operated over a larger surface area of first electrode, which may be desirable in certain use cases, such as the treatment of foodstuffs, pharmaceutical compounds or other relatively delicate materials.

A fluid-base temperature control system may comprise a reservoir of a suitable fluid (e. g water or mineral oil), piped in close proximity to, and thermal contact with, the first electrode. The fluid is circulated from the reservoir using a suitable pump. In-line with the pipe is a temperature control unit comprising a heater and a cooler which is operable to either raise or lower the temperature of the fluid in the pipe and so raise or lower the temperature of the first electrode or dielectric in a corresponding manner. The rating of the heater and cooler is selected according to the rapidity with which is required to change the fluid temperature to thereby change the electrode/dielectric temperature. This will depend largely on the dimensions of the electrode/dielectric and the apparatus in which it is installed.

It is important to note that the temperature control unit 130, if attached to an electrode, is thermally connected to, but otherwise electrically insulated from the first electrode 101. In certain embodiments, the potential difference between the first electrode 101 and the second electrode 102 may be in the region of 1-30 KV, or more typically 5-15 KV. It should be noted that this should not be a DC voltage and should, instead, by time-varying e.g. AC or pulsed in some way.

In most implementations of the invention, it is important to ensure that arcing does not occur and so the temperature control of the first electrode 101 should be undertaken such that good thermal contact is achieved whilst ensuring that there is no electrical contact. Prior art systems are known which utilise a Peltier temperature control element as one of the electrodes. This runs the risk of electrical interference from the plasma generation interfering with surrounding electronic systems, such as the temperature control unit 130 and sensors 140, 150. Embodiments of the invention electrically separate the voltage 110 applied for plasma creation from any electronics or signals associated with operating the temperature control unit 130, whether it is Peltier or fluid based.

By controlling the temperature of the first electrode/dielectric, it is found that better and more accurate control of the apparatus can be achieved. In particular, control of the desired species can be better controlled than if, for instance, temperature of the surrounding environment is controlled.

Although reference is made to temperature control of the first electrode, note that the same effect can be achieved by temperature control of the second electrode or both the first and the second electrode as well as the dielectrics. In some ways, controlling the temperature of the electrode is a proxy for controlling the temperature of the dielectric.

As shown in FIGS. 1A and 1B, the apparatus comprises a sensor 140. Preferably, the sensor 140 comprises a thermocouple. The sensor may also comprise a thermal imager, and/or an IR pyrometer. In FIGS. 1A and 1B, the sensor 140 is configured to measure a temperature of the first dielectric barrier 121. However, the sensor 140 may be configured to measure the temperature of one of the first electrode 101, the second electrode 102, the first dielectric barrier 121 or the second dielectric barrier 122.

As shown in FIGS. 1A and 1B, the apparatus comprises a detector 150. The detector 150 is configured to determine a concentration of a primary chemical species of the plasma. As alluded to above, the primary chemical species may be a reactive nitrogen species or a reactive oxygen species. In the case that the primary chemical species is a reactive nitrogen species, the detector 150 is configured to detect nitrogen dioxide (NO₂). In the case that the primary chemical species is a reactive oxygen species, the detector 150 is configured to detect ozone (O₃). Advantageously, nitrogen dioxide and ozone are respectively indicative of reactive nitrogen species and reactive oxygen species. Advantageously, control of reactive nitrogen species is important for controlling water toxicity, and control of reactive oxygen species is important for effective use in destruction of bacteria.

The detector 150 may include one or more of a UV spectrometer, an IR spectrometer, an FTIR spectrometer, an optical emission spectrometer, a mass spectrometer, an optical absorption spectrometer, a cavity ring down spectrometer and a laser induced fluorescence spectrometer. For example, the detector 150 may include UV/IR spectrometer coupled to a UV light for quantification of ozone. FTIR spectroscopy can be used to detect both nitrogen dioxide and ozone.

As shown in FIGS. 1A and 1B, the apparatus comprises a processor 160. A processor may mean a microprocessor or computer. More specifically, the processor 160 may be a proportional-integral-derivative controller or bang-bang controller. The processor 160 may exploit predicative control and machine learning methods to, for example, facilitate automated control of plasma composition.

The processor 160 is configured to control the temperature control unit 130 based on the measured temperature and the determined concentration. To that end, the processor 160 is in communication with the temperature control unit 130, the sensor 140 and the detector 150. The processor 160 may be in wireless communication with the temperature control unit 130, the sensor 140 and the detector 150.

The processor 160 may be configured to adjust the power supplied to the temperature control unit 130 by the power source 110 in order to control the temperature of the first electrode 101. For instance, the processor 160 may be configured to increase the power supplied to the temperature control unit 130 by the power source 110 to increase the temperature of the first electrode 101 or decrease the power supplied to the temperature control unit 130 by the power source 110 to reduce temperature of the first electrode 101.

In a first mode (i.e., a first chemical regime), the processor 160 may be configured to determine whether the concentration is above a first predetermined threshold, the first predetermined threshold being zero (or close to zero, e.g., <1%, <5%, <10%), and the processor 160 may be configured to control the temperature control unit 130 only if the concentration is above the first predetermined threshold. In this way plasma may be generated that comprises 100% (or near to 100%, e.g., >99%, >95%, >90%) of a desired species. For instance, in the case of reactive nitrogen species and reactive oxygen species, a transition between generation of plasma comprising reactive oxygen species and reactive nitrogen species is a runaway process that is irreversible. By detecting the early formation of reactive nitrogen species prior to runaway (i.e., when the concentration is above the predetermined threshold of zero) and applying the appropriate level of cooling/heating the composition of the plasma can be manipulated to maintain 100% reactive oxygen species.

In a second mode (i.e., a second chemical regime), the processor 160 may be configured to determine whether the concentration is above a second predetermined threshold, the second predetermined threshold being non-zero, and the processor 160 may be configured to control the temperature control unit 130 only if the concentration is above the second predetermined threshold. For example, a desired plasma comprising an equal concentration of reactive nitrogen and reactive oxygen species occurs when the first electrode 101 is at a particular temperature. Therefore, by adjusting the power supplied to the first electrode 101 in response to a concentration of one of the reactive nitrogen species and the reactive oxygen species being above 50%, generation of a plasma comprising an equal concentration of reactive nitrogen and reactive oxygen species can be maintained.

The apparatus may be switchable between the first mode and the second mode. Consequently, the apparatus may operate in a mode in which the plasma generated comprises 100% of a reactive nitrogen species or 100% of a reactive oxygen species and a mode in which the plasma generated comprise a mixture of reactive nitrogen species and reactive oxygen species. Advantageously, therefore, the apparatus facilitates different modes of plasma generation such that the apparatus is useful across a range of applications with different requirements with respect to the composition of the plasma generated.

The apparatus may be powered by a dedicated power source (i.e., a power source different to the power source coupled to the first electrode), enabling prolonged use. Alternatively, the apparatus may include a battery, enabling use without the need of, for instance, a mains power source.

FIG. 3 shows a method of controlling a composition of a plasma according to an embodiment. The method comprises attaching (S1) the temperature control unit 130 to the first electrode 101; measuring (S2) a temperature of the first electrode 101, second electrode 102, first dielectric barrier 121 or second dielectric barrier 122 using the sensor 140; determining (S3) a concentration of a primary chemical species of the plasma using the detector 150; and controlling (S4) the temperature control unit 130 based on the measured temperature and the determined concentration.

The method may comprise controlling the temperature control unit 130 in the first mode and in the second mode and switching between these modes, as described above in relation to FIGS. 1A and 1B. Similarly, the primary chemical species may be a reactive nitrogen species (e.g., nitrogen dioxide) or a reactive oxygen species (e.g., ozone) as described above in relation to FIGS. 1A, 1B and 2.

In summary, the invention an apparatus for controlling a composition of a plasma and a method of controlling a composition of a plasma that that facilitates different modes of plasma generation such that plasma composition can be precisely controlled, enabling application of plasma technology across a range of fields and industries.

The optional features set out herein may be used either individually or in combination with each other where appropriate and particularly in the combinations as set out in the accompanying claims. The optional features for each aspect or exemplary embodiment of the invention, as set out herein are also applicable to all other aspects or exemplary embodiments of the invention, where appropriate. In other words, the skilled person reading this specification should consider the optional features for each aspect or exemplary embodiment of the invention as interchangeable and combinable between different aspects and exemplary embodiments.

All of the features disclosed in this specification (including any accompanying claims and drawings), and/or all of the steps of any method or process so disclosed, may be combined in any combination, except combinations where at most some of such features and/or steps are mutually exclusive.

Although a preferred embodiment has been shown and described, it will be appreciated by those skilled in the art that various changes and modifications might be made without departing from the scope of the invention, as defined in the appended claims and as described above.

1. An apparatus for controlling a composition of a plasma, comprising a pair of electrodes having a dielectric barrier therebetween, the apparatus further comprising:
a temperature control unit in thermal contact with one of the electrodes or the dielectric barrier;
a sensor configured to measure a temperature of one of electrodes or the dielectric barrier;
a detector configured to determine a concentration of a primary chemical species of the plasma; and
a processor configured to control the temperature control unit based on the measured temperature and the determined concentration.

2. The apparatus of claim 1 wherein a power source for attachment to the pair of electrodes is electrically insulated from the temperature control unit.

3. The apparatus of claim 1, wherein, in a first mode: the processor is configured to determine whether the concentration is above a first predetermined threshold, the first predetermined threshold being zero, and the processor is configured to control the temperature control unit only if the concentration is above the first predetermined threshold.

4. The apparatus of claim 1, wherein, in a second mode: the processor is configured to determine whether the concentration is above a second predetermined threshold, the second predetermined threshold being non-zero, and the processor is configured to control the temperature control unit only if the concentration is above the second predetermined threshold.

5. The apparatus of claim 1,
wherein, in a first mode: the processor is configured to determine whether the concentration is above a first predetermined threshold, the first predetermined threshold being zero, and the processor is configured to control the temperature control unit only if the concentration is above the first predetermined threshold,
wherein, in a second mode: the processor is configured to determine whether the concentration is above a second predetermined threshold, the second predetermined threshold being non-zero, and the processor is configured to control the temperature control unit only if the concentration is above the second predetermined threshold, and
wherein the apparatus is switchable between the first mode and the second mode.

6. The apparatus of claim 1, wherein the primary chemical species is a reactive nitrogen species.

7. The apparatus of claim 6, wherein the detector is configured to detect nitrogen dioxide.

8. The apparatus of claim 1, wherein the primary chemical species is a reactive oxygen species.

9. The apparatus of claim 8, wherein the detector is configured to detect ozone.

10. The apparatus of claim 9, wherein the detector comprises at least one of a UV spectrometer and an IR spectrometer.

11. The apparatus of claim 1, wherein the sensor comprises a thermocouple.

12. The apparatus of claim 1, wherein the temperature control unit is attachable to the one electrode or the dielectric barrier via a thermal interface material.

13. The apparatus of claim 1, wherein the temperature control unit is one of a thermoelectric module or a temperature-controlled fluid system.

14. The apparatus of claim 1, wherein the dielectric material comprises at least one of alumina and quartz.

15. The apparatus of claim 1 arranged in either a surface barrier discharge, SBD, configuration or a dielectric barrier discharge, DBD, configuration.

16. A method of controlling a composition of a plasma generated by a pair of electrodes having a dielectric barrier therebetween, the method comprising:
providing a temperature control unit in thermal contact with one of the electrodes or the dielectric barrier;
measuring a temperature of one of the electrodes or the dielectric barrier using a sensor;
determining a concentration of a primary chemical species of the plasma using a detector; and
controlling the temperature control unit based on the measured temperature and the determined concentration.

17. A non-transitory computer-readable medium comprising instructions which, when executed by a computer, cause the computer to carry out the steps of the method of claim 16.
